(19) United States
(12) Patent Application Publication
(10) Pub. No.: US 2015/0131824 A1
(43) Pub. Date: May 14, 2015

(54) METHOD FOR HIGH QUALITY EFFICIENT 3D SOUND REPRODUCTION

(71) Applicants: Khoa-Van Nguyen, Paris (FR); Etienne Corteel, Malakoff (FR)

(72) Inventors: Khoa-Van Nguyen, Paris (FR); Etienne Corteel, Malakoff (FR)

(73) Assignee: SONICEMOTION AG, Oberglatt (CH)

(21) Appl. No.: 14/389,463

(22) PCT Filed: Mar. 25, 2013
(86) PCT No.: PCT/EP2013/056216

§ 371 Date: Sep. 30, 2014

(30) Foreign Application Priority Data
Apr. 2, 2012 (EP) 12162855.6

(51) Int. Cl. H04R 5/02; H04S 7/00

(52) U.S. Cl. CPC H04R 5/02; H04S 7/00
USPC 381/300

(57) ABSTRACT

A method for spatial sound reproduction from a first audio input signal includes using a plurality of loudspeakers using a plurality of virtual loudspeakers over which the first audio input signal is panned for forming second audio input signals using source positioning data and virtual loudspeakers positioning data. The virtual loudspeakers are synthesized by modifying second audio input signals forming third audio input signals using virtual loudspeaker spatial filter coefficients that align the loudspeakers. The method includes the steps of extracting equalization filter coefficients using source positioning data and modifying the first audio input signals using equalization filter coefficients

The invention relates to a method for spatial sound reproduction from a first audio input signal using a plurality of loudspeakers, said method using a plurality of virtual loudspeakers over which the first audio input signal is panned forming second audio input signals using source positioning data and virtual loudspeakers positioning data, said virtual loudspeakers being synthesized by modifying second audio input signals forming third audio input signals using virtual loudspeaker spatial filter coefficients that aliment the loudspeakers, said method comprising steps of extracting equalization filter coefficients using source positioning data and modifying the first audio input signals using equalization filter coefficients.

### DESCRIPTION OF STATE OF THE ART

Sound spatialization techniques aim at positioning a monophonic sound object in an auditory so as to create a virtual sound source at the target position. There are numerous sound spatialization means. The common ones in the consumer market are 2 channels stereophony and the 5.1 surround sound. In these techniques the virtual source direction is often obtained with amplitude panning among the loudspeaker channels, depending on the target position and the loudspeaker channel spatial distribution. This creates the illusion for a listener located at the center of the loudspeaker distribution that a sound positioned in between two loudspeakers. These stereophonic based techniques have been extended to other loudspeaker setup such as 7.2, 22.2 etc and allows for a more accurate virtual source rendering. The main advantage of stereophonic based techniques is the simplicity of the signal processing operations required for positioning sound objects, only gains, no filtering.

There are several other techniques to spatialize sound sources. The first ones such as Wave Field Synthesis or High Order Ambisonics use a loudspeaker setup to render a sound field in an extended listening area based on an mathematical analysis as disclosed by A. J. Berkhout, D. de Vries, and P. Vogel. In “Acoustic control by wave field synthesis”, Journal of the Acoustical Society of America, 93:2764-2778, 1993 and J. Daniel in “Representation de champs acoustiques, application à la transmission et a la reproduction de scènes sonores complexes dans un contexte multimedia” PhD thesis, universitè Paris 6, 2000, respectively. The second kind of technique is the binaural technology, as disclosed by F. L. Wightman and D. J. Kistler in “Headphone simulation of free-field listening. I: Stimulus synthesis”, Journal of the Acoustical Society of America, 85(2), February 1989, that uses only headphones to reproduce spatialized sound sources directly at the ears of the listener. It is based on Head Related Transfer Functions that mimic the temporal and spectral mechanisms of human auditory localization. The extension of binaural principles to loudspeaker rendering is called Transaural and consists in cancelling the acoustic crosstalk paths between loudspeakers and ears so as to deliver only the appropriate signal to the corresponding ear as disclosed by D. Cooper and J. Bauck. In [symbol] Prospects for transaural recording [symbol] , Journal of the audio Engineering Society, 37(1/2):3-19, 1989.

These high quality techniques rely on complex filtering that depend on the virtual source position and the number of loudspeakers. At the end, for each source, one filter is needed for each loudspeaker. The number of filters to process can increase quickly when multiplying the number of sources and loudspeakers reaching high computational power requirements either for demanding techniques such as WFS or in mobile applications where the processing unit is limited.

One solution to overcome this issue is to use an intermediate layer of “virtual loudspeakers” through which desired virtual source are rendered using simple panning techniques. Hence it is possible to synthesize a large number of sound sources while keeping a fixed number of filters to synthesize the virtual loudspeakers. Spatial sound rendering over a limited number of virtual loudspeakers can be applied to all the above-mentioned spatialization techniques. For example, as disclosed by E. Corteel, S. Roux, and O. Warusfel in [symbol] Creation of virtual sound scenes using wave field synthesis [symbol] , Hannovre: Tonmeistertagung, 2002, virtual sources can be spatially positioned using vector-based amplitude panning (VBAP) or High Order Ambisonics over a limited number of virtual loudspeakers synthesized as plane waves or point sources using WFS over a larger number of loudspeakers. This solution can be found also in the context of room rendering and auralization, where the number of sources is very high as disclosed by R. Pellegrini in [symbol] Perception-Based Room Rendering for Auditory Scenes [symbol] , Preprints—Audio Engineering Society, 2000. Indeed, each primary source generates a large number of reflections that are to be synthesized as well. Using virtual loudspeakers to generate the reflections becomes an efficient solution to perform auralization. All existing reflections for any virtual primary sources can share the virtual loudspeaker array and the reflections process remains limited to the fixed number of virtual loudspeakers.

The use of virtual loudspeaker does not only reduce the actual real time processing cost as mentioned above, it also significantly reduces the number of filters stored in memory. Indeed, all the above-mentioned spatialization techniques require an important filter database for each available virtual source position and each loudspeaker. In the case of large multiple loudspeakers' array such as WFS rendering, it often results to a large number of filters as disclosed by E. Corteel in [symbol] Equalization in an extended area using multichannel inversion and wave field synthesis [symbol] , Journal of the audio Engineering Society, 54(12):1140-1161, 2006. This is even worse when a 3D loudspeaker setup is considered.

Virtual loudspeakers can also be used for rendering already mixed content such as stereo or 5.1. The content is directly played over the virtual loudspeakers rendered by a specific spatialization technique. In the case of headphone rendering, this technique is used to produce 5.1 on headphone as disclosed by M. Gebhardt, C. Kuhn and R. Pellegrini in “Headphones technology for surround sound monitoring—A Virtual 5.1 Listening Room”, Audio Engineering Society Convention 122, 2007. In the case of WFS rendering, using a setup of 5.1 virtual loudspeakers rendered as plane waves allows increasing the listening area and overcome the sweet spot issue as disclosed by M. Boone and E. Verheijen in [symbol] Multi-channel sound reproduction based on wave field synthesis [symbol] , Preprints—Audio Engineering Society, 1993.

Multichannel loudspeaker reproduction techniques often comprise an equalization step. The process of equalizing is done to compensate for possible coloration artifacts that can come from the acoustical characteristics of the loudspeakers/listening room and/or from the signal processing done by the spatialization technique. There are several ways to equalize a sound reproduction system. The most straightforward is to make an individual equalization of each loudspeaker of the sound reproduction system. The method is usually to measure the impulse response of each loudspeaker separately and to correct the artifacts separately so that all loudspeakers share the same spectral content.

The second method is know as multichannel equalization technique as disclosed by E. Corteel in [symbol] Equalization in an extended area using multichannel inversion and wave field synthesis [symbol] , Journal of the audio Engineering Society, 54(12):1140-1161, 2006. The method consists in having the response of the whole loudspeaker array corresponding to a target response at specific control location. The control location is defined by an array of control microphone. Each loudspeaker is measured on the microphone array. Then multichannel equalization corresponds in MIMO inversion problem that intend to fit the loudspeaker response measured on the microphone array to the target response. The improvement given by multichannel equalization compared to individual equalization is that it ensures a better sound reproduction over a large listening area, which is the first aim of WFS.

Binaural rendering needs specific process regarding the equalization. The first step consists in equalizing the headphone, as disclosed by D. Pralong and S. Carlile in [symbol] The role of individualized headphone calibration for the generation of high fidelity virtual auditory space [symbol] , The Journal of the Acoustical Society of America, 100:3785, 1996, so that the headphones' frequency response is as flat as possible and does not interfere with binaural rendering. However, the benefits of headphone equalization are debatable since the measurement is not easily reproducible due to the variability in the headphone placement over the head and the microphones placement in the ears, as disclosed by A. Kulkarni and H. Colburn in [symbol] Variability in the characterization of the headphone transfer-function [symbol] , The Journal of the Acoustical Society of America, 107:1071, 2000.

The second problem with binaural rendering is to perform equalization of the Head Related Transfer Functions (HRTFs). Indeed, HRTFs are the filtering core of binaural rendering. These filters represent the acoustic transformation of a sound wave on its path from the emission position to the eardrums, including reflection, absorption and diffraction effects on the listener's ears, head and torso. If one filters a monophonic source using a pair of HRTF (for the left and the right ear), the source will finally be heard at the three-dimensional position specified by the HRTF filters. HRTFs are responsible for localizing sound sources on the one hand, but on the other hand, they are also known to bring important coloration effects. These coloration effects are not acceptable for consumer market purpose, and a proper HRTF equalization is also needed.

As disclosed by J. Merimaa in [symbol] Modification of hrtf filters to reduce timbral effects in binaural synthesis [symbol] , In AES 127th Convention, (New York, N.Y., USA), 2009, an HRTF equalization method can be done by summing left and right HRTF magnitude spectrum over a given frequency bandwidth. However, HRTF equalization often cancels the spectral cues needed for spatialization. At the end, binaural rendering consists in a tradeoff between timbre coloration and spatialization.

The latter equalization for binaural rendering is actually an example of equalization for a virtual loudspeaker setup itself that can be done for any virtual loudspeaker setup. However, using virtual loudspeakers, the final virtual source position is computed with simple panning techniques applied to the virtual loudspeakers' setup. The drawback of such method is that the panning technique may bring some coloration artifacts when summing several loudspeakers' contributions. In the case of binaural rendering for example, HRTFs filters contain spatial cues that are at the same time spectrally colored. When recombining these HRTFs with a panning law, some spectral features can arise or vanish, depending on the direction given by the panning and finally bring other unexpected coloration effects.

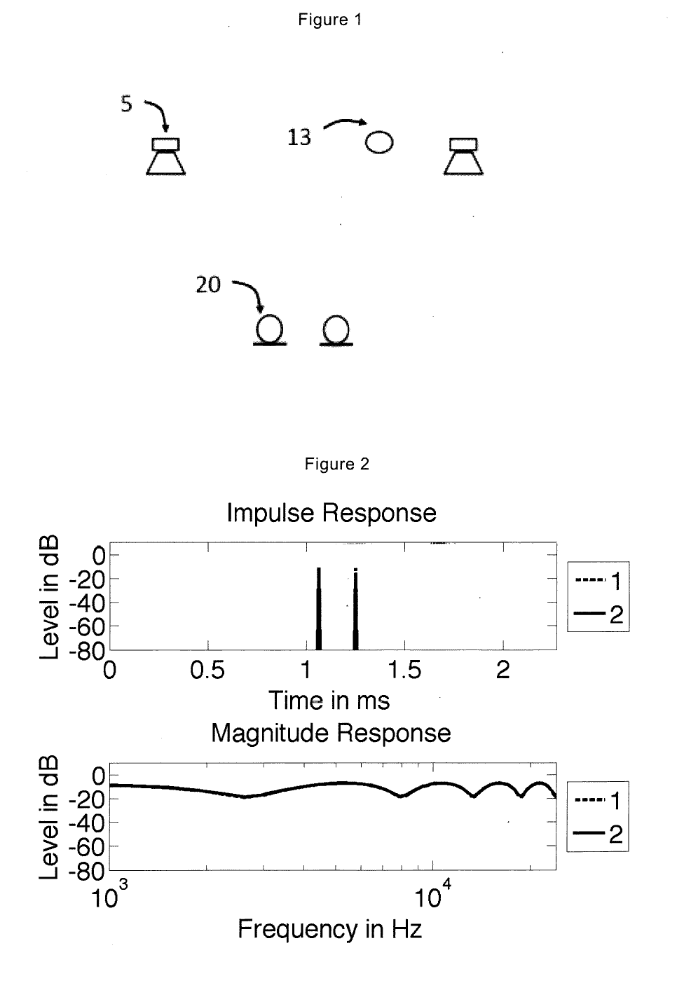

FIG. 1 describes a typical stereo loudspeakers setup. The loudspeakers 5 synthesize a virtual source 13 using an amplitude-panning device 10. The signal is simulated on two microphones 20 with 10 cm spacing so as to mimic rough ear spacing. FIG. 2 shows the results of the simulation of a stereo panning on the setup described in FIG. 1. The two loudspeakers 5 and the two microphones 20 are considered as ideal. The frequency response shows several notches in the frequency response due to a comb filtering effect caused by the propagation delay between the two loudspeakers observed in the impulse response. These kind of spectral characteristics are typically heard as coloration artifacts that need to be compensated for.

### Aim of the Invention

The aim of the invention is to provide means for optimizing the spatial rendering of sound using virtual loudspeakers. It is another aim of the invention to improve the timbre of a synthesized virtual source. It is another aim of the invention to reduce the number of filters stored in memory that are needed to spatialize the sound sources. It is another aim of the invention to limit the processing power required to spatialize the virtual sources. It is also an aim of the invention to improve the rendering quality of spatial reproduction of spatially encoded content (stereo, 5.1, . . . ) using virtual loudspeakers.

### SUMMARY OF THE INVENTION

The invention consists in a method for optimizing the quality of spatial sound rendering using panning over a limited number of virtual loudspeakers, located in the horizontal plane and/or in elevation, that are synthesized over loudspeakers or headphones using a multichannel sound rendering technique. The invention can be applied to any sound rendering technique based on virtual loudspeakers.

The method consists in equalizing the virtual source depending on its position when it is synthesized over virtual loudspeakers. A first step of the method is to define equalization rules depending on the virtual source position, as well as taking into account the previous rendering setup parameters such as equalization and position of the virtual loudspeakers. To compute the equalization filter for a given source direction, the method consists in simulating the rendering of the virtual source on the set of virtual loudspeakers using a simple panning technique based on gains and/or delays. In a setup of virtual loudspeakers, the method applies gain coefficients and or delays to each virtual loudspeaker depending on the position of the virtual source with respect to the virtual loudspeakers, using panning techniques such as stereo panning, VBAP or HOA as described before. The method simulates the response of the virtual loudspeakers on a plurality of microphones using simulated or measured data. The characteristics of the loudspeakers and virtual loudspeakers are taken into account, as well as their respective individual equalization and rendering steps. The microphone positioning aims at estimating the response of the system in the listening area. Therefore, the number of microphones can be varied from 1 to a large number, spanning an extending listening area for WFS or simulating response at the ears of the listener for binaural rendering. The responses at the microphones are further processed in order to create a target temporal response or frequency profile for the equalization filter. The equalization filter is then computed as an IIR or an FIR filter for a large number of target virtual positions and stored in a database. The equalization filter is finally applied to the audio input signal corresponding to the target position before the whole spatial rendering process.

The method consists in a position dependent equalization. In the case of sound object spatialization, the position is given along with an audio input signal. When the audio signals are already mixed such as stereo or 5.1 content, the audio signals need to be analyzed so as to extract directional information. The analysis decomposes the audio input signals into frequency bands. The frequency bands can be defined as auditory frequency bands or third octave/octave bands. Then the method cross-analyzes in each frequency bands the between-channels correlation values and/or level differences to estimate one or several directions for the given frequency band of the audio input signals. Based on the analysis result, the corresponding equalization filter is extracted from the equalization filter database and used to process the input signals.

The advantage of the method is first that the equalization allows limiting spectral coloration to the final spatialized sound rendering. The equalization reduces the possible coloration artifacts that arise after the virtual source synthesis because of the spectral characteristics of the virtual loudspeakers. Compared to standard virtual loudspeakers' rendering, the invention offers an additional equalization step that allows a better control of the final rendering.

Another advantage is the reduction of memory and power computation needed compared to a “raw” spatialization technique such as WFS or binaural rendering. Indeed, in the case of WFS for example, the system must store an amount of filters in database of

N source positions*M loudspeakers.

Often the number of positions is high because it consists in a source grid that covers the whole area of possible source locations.

The use of virtual loudspeakers rendering directly lowers the numbers of filters stored in database. In that case, the number of filters in the database is

P virtual loudspeakers*M loudspeakers, with P<<N.

The invention consists in adding, on top of the virtual loudspeaker rendering, an equalization step per source position that is applied to all the virtual loudspeakers. The invention finally ends up with a number of filters of

P virtual loudspeakers*M loudspeakers+N source positions.

The same reasoning is available for the power computation cost. With raw spatialization techniques, the system has to process at the same time a number

N sound objects*M loudspeakers

Using virtual loudspeakers, the number of processed filters is

P virtual loudspeakers*M loudspeakers

Then, using virtual loudspeakers becomes efficient when N>P, which is often the case, since P is usually lower than 10 and N should be as much as possible.

In terms of processing, the invention adds an equalization step per sound object, applied to all the virtual loudspeakers. The number of processed filters is finally

P virtual loudspeakers*M loudspeakers+N sound objects

At the end, the number of filters to store and to process is lower than a raw spatialization technique but higher than using virtual loudspeakers. The invention finally corresponds to a tradeoff between the processing and memory needs of the “raw” spatialization and the lack of timbre control on a virtual loudspeakers based technique.

Another advantage of the method is that it can be simple and not costly since it can benefit from the previous equalization steps. Indeed, the conventional procedure is to equalize the rendering system first, and possibly equalize the virtual loudspeakers then. Thus, the third equalization step brought by the invention may be simple in terms of processing. The equalization parameters can even be computed in real time depending on the direction of the sound objects.

In other words, there is presented here a method for spatial sound reproduction from a first audio input signal using a plurality of loudspeakers, said method using a plurality of virtual loudspeakers over which the first audio input signal is panned forming second audio input signals using source positioning data and virtual loudspeakers positioning data, said virtual loudspeakers being synthesized by modifying second audio input signals forming third audio input signals using virtual loudspeaker spatial filter coefficients that aliment the loudspeakers, said method comprising steps of extracting equalization filter coefficients using source positioning data and modifying the first audio input signals using equalization filter coefficients.

Furthermore, the method may comprise steps wherein the equalization filter coefficients are retrieved from a filter database depending on the source positioning data. And the method may also comprise steps:
wherein the equalization filter coefficients are calculated from an estimation of the reproduced sound field in the listening area.
wherein the estimation of the reproduced sound field in the listening area is performed by capturing the reproduced sound field on a plurality of microphones situated within the listening area.
wherein the reproduced sound field is measured on a plurality of microphones in the target listening environment.
wherein the reproduced sound field is simulated based on loudspeaker description data.
wherein the virtual loudspeaker spatial filter coefficients are calculated using loudspeaker description data and virtual loudspeakers positioning data.
wherein the virtual loudspeaker spatial filter coefficients comprise individual equalization of the loudspeakers.
wherein the virtual loudspeaker spatial filter coefficients are calculated for reproducing a target sound field at the ears of the listener using binaural reproduction over headphones or transaural reproduction over loudspeakers.
wherein the virtual loudspeaker spatial filter coefficients are calculated for sound field reproduction using Wave Field Synthesis or High Order Ambisonics.

There is also presented here a method for spatial sound reproduction from a plurality of first audio input signal described by channel positioning data using a plurality of loudspeakers, said method using a plurality of virtual loudspeakers over which the first audio input signal, said virtual loudspeakers being synthesized by modifying first audio input signals forming third audio input signals using virtual loudspeaker spatial filter coefficients that aliment the loudspeakers, said virtual loudspeaker spatial filter coefficients being calculated based on channel positioning data, said method comprising steps of performing a spatial analysis is performed on a plurality of input signals using channel positioning data forming analysis positioning data, extracting equalization filter coefficients using analysis positioning data, and modifying the plurality of first audio input signals using equalization filter coefficients.

Furthermore, the method may comprise steps wherein the equalization filter coefficients are retrieved from a filter database depending on the analysis positioning data. And the method may also comprise steps:
wherein the analysis positioning data are computed in a plurality of frequency bands.
wherein the equalization filter coefficients are computed in a plurality of frequency bands using the analysis positioning data.
wherein the equalization filter coefficients are calculated from an estimation of the reproduced sound field in the listening area.
wherein the estimation of the reproduced sound field in the listening area is performed by capturing the reproduced sound field on a plurality of microphones situated within the listening area.
wherein the reproduced sound field is measured on a plurality of microphones in the target listening environment.
wherein the reproduced sound field is simulated based on loudspeaker description data.
wherein the virtual loudspeaker spatial filter coefficients are calculated using loudspeaker description data and virtual loudspeakers positioning data.
wherein the virtual loudspeaker spatial filter coefficients comprise individual equalization of the loudspeakers.
wherein the virtual loudspeaker spatial filter coefficients are calculated for reproducing a target sound field at the ears of the listener using binaural reproduction over headphones or transaural reproduction over loudspeakers.
wherein the virtual loudspeaker spatial filter coefficients are calculated for sound field reproduction using Wave Field Synthesis or High Order Ambisonics.

The invention will be described with more detail hereinafter with the aid of examples and with reference to the attached drawings, in which

FIG. 1 represents a standard stereo loudspeaker setup using a simple panning technique to synthesize a virtual source. The sound field is recorded on two microphones.

FIG. 2 represents the simulation results of the setup described in FIG. 1.

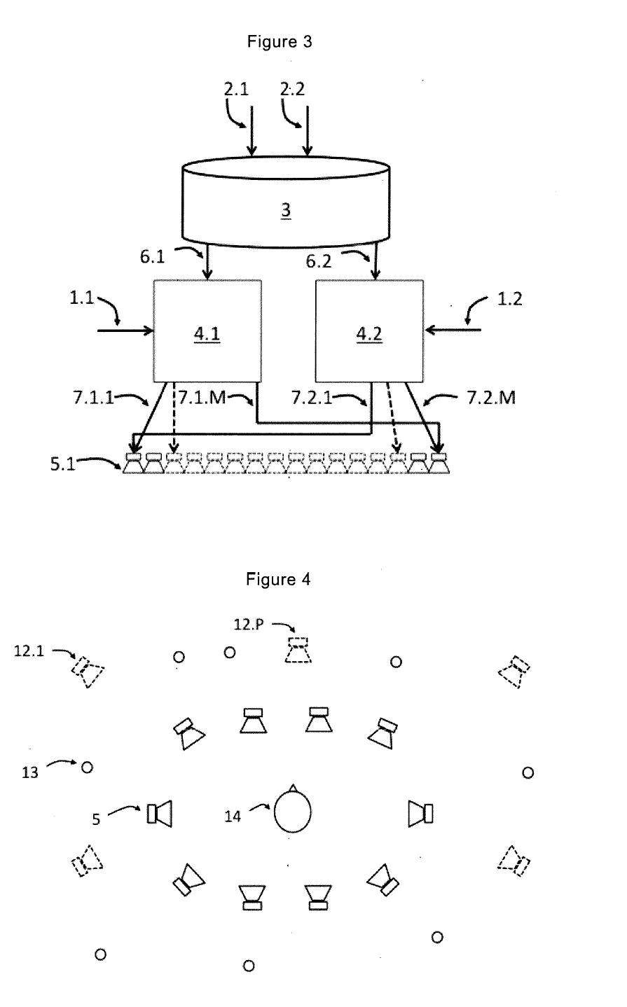

FIG. 3 represents 3D sound rendering with a standard spatialization technique.

FIG. 4 illustrates the rendering of several virtual sources through virtual loudspeakers.

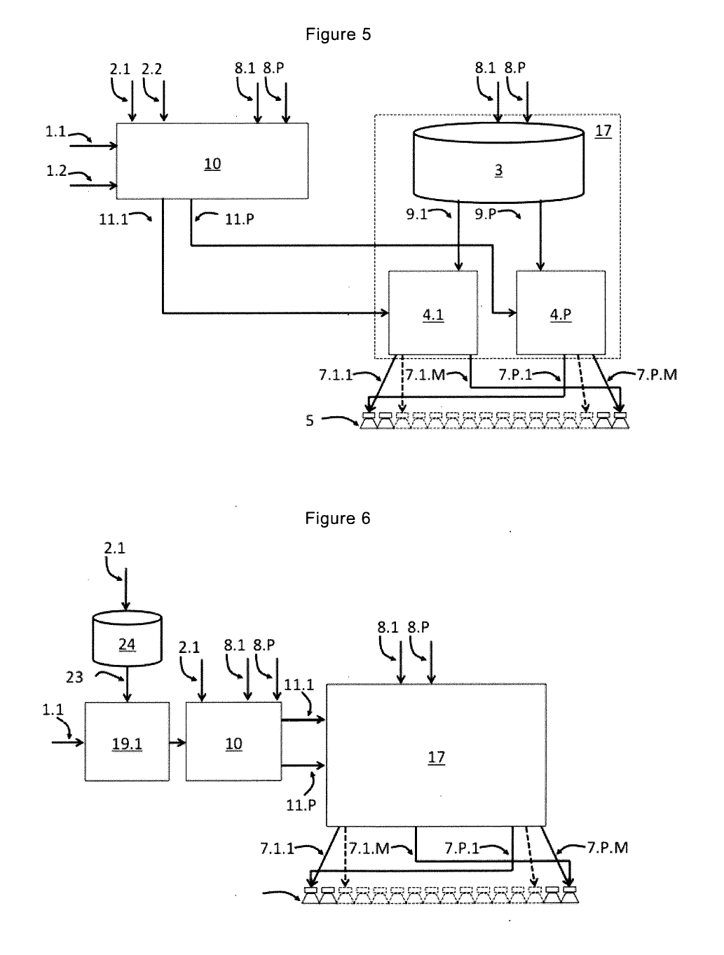

FIG. 5 represents 3D sound rendering of virtual loudspeakers with standard spatialization techniques.

FIG. 6 represents the equalization method of the invention.

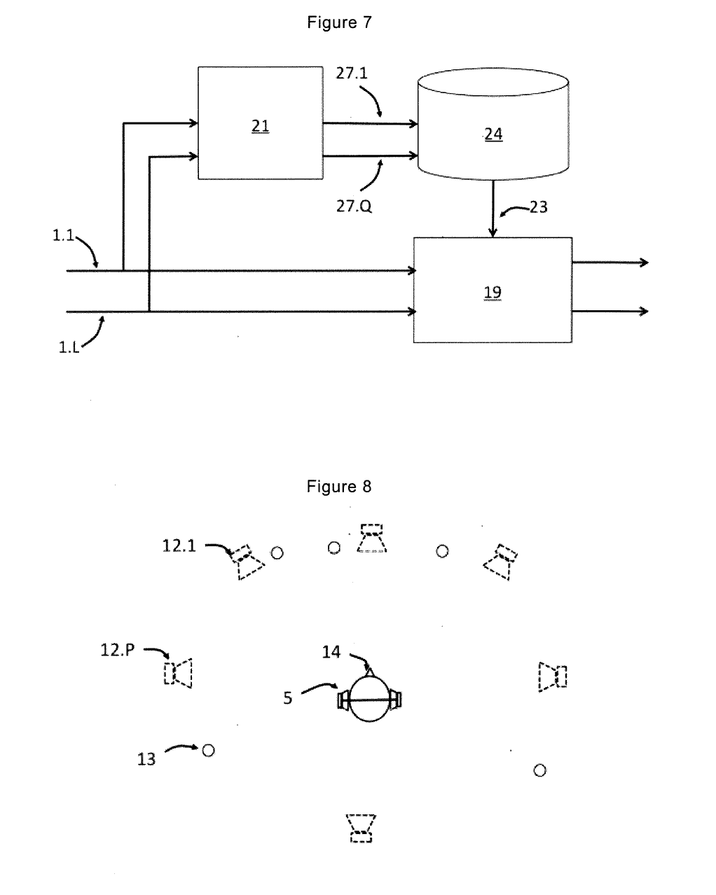

FIG. 7 represents the method for extracting the position from already mixed content.

FIG. 8 represents a first embodiment according to the invention.

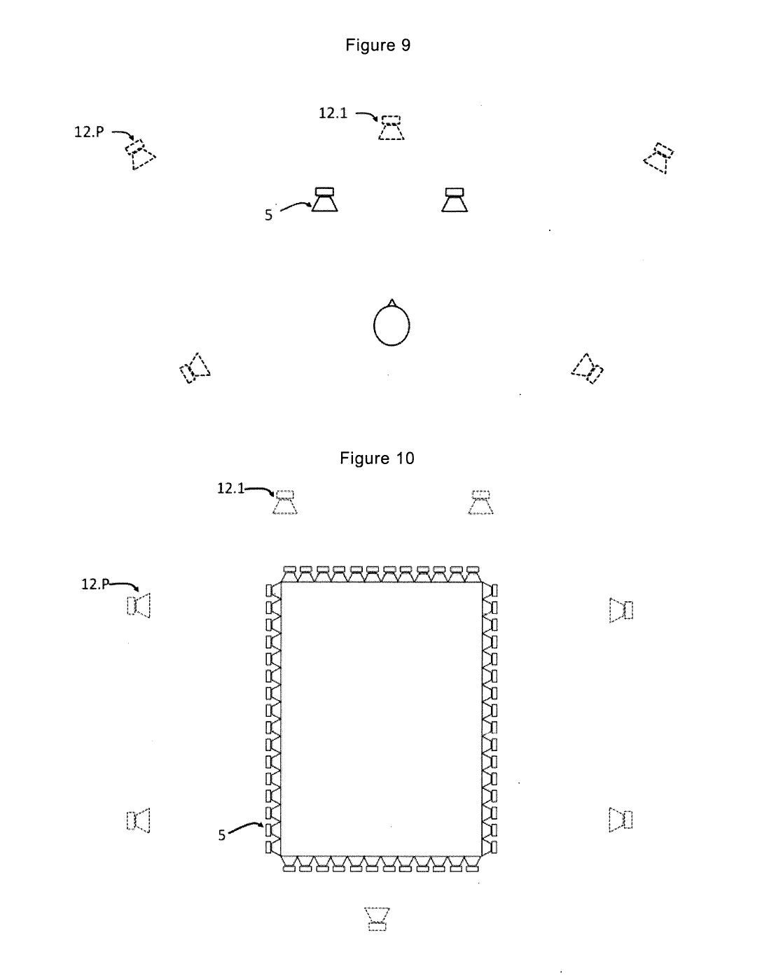

FIG. 9 represents a second embodiment according to the invention.

FIG. 10 represents a third embodiment according to the invention.

### DETAILED DESCRIPTION OF FIGURES

FIG. 1 has been described in the state of the art.

FIG. 2 has been described in the state of the art.

FIG. 3 describes 3D sound rendering with standard spatialization techniques such as WFS, binaural or transaural rendering. An audio input signal 1.1 is sent to a filtering device 4.1. The position data 2.1 corresponding to the audio input signal 1.1 is sent to a spatial filter database 3 that provides a spatial filter coefficients 6.1. The filtering device 4.1 processes the audio input signal 1.1 with the set of spatial filter coefficients 6.1 to form a plurality of spatialization audio output signals 7.1.1 to 7.1.M that feed the M loudspeakers 5.1 to 5.M. If a second audio input signal 2.2 is to be sent, the process is the same and it ends up with doubling the processing power. The spatial filter database 3 contains all the spatial filter coefficients to send to each of the M loudspeakers for any of the N available positions.

FIG. 4 is an illustration of 3D sound rendering using virtual loudspeakers. The spatialization system consists in M loudspeakers 5. The spatialization system synthesizes the P virtual loudspeakers 12.1 to 12.P. The latter finally synthesize the virtual source 13 by amplitude panning. The listener 14 hears the virtual source 13 at the target position. The advantage here is that the spatialization system only synthesizes the P virtual loudspeakers 12.1 to 12.P. It is possible to render as many virtual sources as desired because it is handled by the virtual loudspeakers' setup 12.

FIG. 5 describes 3D sound rendering using a set of P virtual loudspeakers 12. A first audio input signal 1.1 is sent to a panning device 10. Based on the sound source positioning data 2.1 corresponding to audio input signal 1.1 and the virtual loudspeakers description data 8.1 to 8.P, the panning device 10 forms a set of second audio input signals 11.1 to 11.P, based on source positioning data 2 and virtual loudspeaker description data 8. The virtual loudspeakers description data 8.1 to 8.P are sent to a spatial filter database 3, that provides the corresponding set of spatial filters 9.1 to 9.P. The filtering device 4.1 (resp. 4.P) processes the second audio input signals 11.1 (resp. 11.P) to form a set of spatialization audio output signals 7.1.1 to 7.1.M (resp. 7.P.1 to 7.P.M) that feed the M loudspeakers 5.1 to 5.M. The spatial filter database 3 only contains P*M spatial filters. For better understanding in the next figures, the components related to the spatialization technique are grouped together as spatial rendering device 17.

FIG. 6 describes the spatial rendering process according to the invention. The invention consists in a source equalization filtering device 19.1. The source equalization filtering device 19 filters the audio input signal 1.1 with filter coefficients 23 that are extracted from a database 24 depending on the virtual source positioning data 2.1. The filtered signal is finally sent the panning device 10, and the spatial processing is done as described in FIG. 5.

FIG. 7 describes the preliminary step of extracting positions from a plurality of first audio input signals 1 comprising L channels according to a multichannel audio content described with channel positioning data 22. A spatial analysis device 21 splits the plurality of first audio input signals 1 into Q frequency bands and performs a spatial analysis using channel positioning data 22 so as to extract analysis positioning data 27.1 to 27.Q for each band. The positioning information 27.1 to 27.Q is transmitted to the equalization filter database 24 that forms full band filter coefficients 23. These filter coefficients are applied to the first audio input signals 1.1 to 1.L and sent to the panning device 10.

### Description of Embodiments

In a first embodiment of the invention, the method is used for binaural synthesis of sound objects (FIG. 8) for use in virtual reality environment or auralization purpose. The virtual loudspeakers 12.1 are distributed around the listener 14. The filtering device 4 synthesizes the virtual loudspeakers 12.1 with virtual loudspeaker spatial filter coefficients 9 stored in the spatial filter database 3. The virtual loudspeaker spatial filter coefficients 9 correspond to HRTFs from the KEMAR manikin as disclosed by B. Gardner, K. Martin in [symbol] HRTF measurements of a kemar dummy-head microphone [symbol] , MIT Media Lab, 1994, that contain spatial acoustic cues of the positions given by the virtual loudspeakers description data. The virtual loudspeaker spatial filter coefficients 9 for one virtual loudspeaker 12 also contain an individual equalization that compensates the timbre coloration effect of the original HRTFs while keeping the spatial effect, as disclosed by J. Merimaa in [symbol] Modification of HRTF filters to reduce timbral effects in binaural synthesis [symbol] , In AES 127th Convention, (New York, N.Y., USA), 2009. The virtual loudspeaker spatial filter coefficients 9 also contain headphone equalization filters. The headphone equalization filters are estimated from headphone measurements on an artificial head with binaural microphones.

Virtual source 13 are synthesized by the virtual loudspeakers 12 with the panning device 10 that uses Vector Based Amplitude Panning (VBAP), as disclosed by V. Pulkki in [symbol] Virtual sound source positioning using vector base amplitude panning [symbol] , Journal of the Audio Engineering Society, 45(6):456-466, 1997, depending on the position contained in the virtual source positioning data 2 compared to the virtual loudspeaker description data 8. The panning device 10 outputs second audio inputs signals that will feed spatial rendering device 17.

The first audio input signal 1, corresponding to virtual source 13 and virtual source positioning data 2, enters the source equalization-filtering device 19. Depending on the virtual source positioning data 2, the source equalization-filtering device 19 contains equalization filter coefficients 23 that are stored in a filter database 24. The equalization filter coefficients 23 depend on the virtual source positioning data 2. Each equalization filter coefficients 23 is computed by simulating the response of the spatial rendering device 17 fed by the second audio input signals 11 delivered by the panning device 10 and characteristics of the virtual source position data 2 and virtual loudspeaker description data 8. In other words, the impulse response of each spatial filters 6, that corresponds to HRTFs at position given by the virtual loudspeaker description data 8, are summed together with the panning coefficients from the VBAP technique. The equalization filters 23 are computed so that the resulting simulated impulse response finally fits a target impulse response. The target impulse response is chosen so as to provide perceptual requirements such as better clarity, better coloration or better bass frequencies.

In a second embodiment of the invention, the method is applied for transaural reproduction of a stereo or 5.1 content (FIG. 9). The transaural speaker system consists in two loudspeakers 5 in front of the listener. The filtering device 4 synthesizes the virtual loudspeakers 12. The filtering device uses spatial filters 6 stored in a spatial filter database 3. The spatial filters 6 corresponds to transaural filters that are computed from HRTFs of a spherical head model, as disclosed by R. Duda and W. Martens in [symbol] Range dependence of the response of a spherical head model [symbol] , Journal of the Acoustical Society of America, 104:3048, 1998. The spatial filters 6 contain spatial acoustic cues corresponding to virtual loudspeaker description data 8 including position of a standard 5.1 setup. The spatial filters 6 also contain cross-talk cancellation filters as disclosed by D. Cooper and J. Bauck in [symbol] Prospects for transaural recording [symbol] , Journal of the Audio Engineering Society 37(1/2):3-19, 1989, that allow to only hear the binaural right (left resp.) signal on the right (left resp.) ear, based on the loudspeaker description data 16 and the listener position. The spatial filters 6 also include loudspeakers equalization filter coefficients that compensate the drawback of the loudspeakers 5. The loudspeakers equalization filters are estimated by free-field measurement of the loudspeakers 5 in an anechoic room.

The first audio input signal 1 is a 5.1 content, which is already mixed according to music or movie needs. An spatial analysis device 21 decomposes the first audio input signal 1 into several sub-band frequencies and extracts analysis-positioning 27 data from each audio input sub band frequency using a method disclosed in WO2012025580 (A1).

The analysis-positioning data 27 are used to extract equalization filter coefficients 23 from the filter database 24 for each sub-band frequency. The final full-band equalization filter coefficients are recomposed from the extracted equalization filters coefficients 23, and is used by the source equalization filtering device to filter the first audio input signals 1.

The equalization filter coefficients 23 are obtained by measuring the impulse response of each virtual loudspeaker 12 synthesized by the spatial rendering device 17 on array of microphones located closed to the listener's position. An ensemble of virtual source positioning data 2 is created so as to describe virtual source positioning all around the listener 14. For each available virtual source positioning data 2, an impulse response is simulated by adding each virtual loudspeakers 12 measurements weighted by the panning coefficients given by the panning device 10, depending on the virtual source positioning data 2 relative to the virtual loudspeaker description data 8. The simulated impulse response is averaged on each microphone and is used as a reference frequency profile. The final source equalization filter coefficients are computed so that the simulated impulse response fits a chosen target frequency profile, which provide appropriate timbre coloration for audio content such as movies or music.

In a third embodiment of the invention, the method is applied to horizontal plane WFS rendering (FIG. 10) for room rendering applications. The WFS system is composed a loudspeaker array 5 enclosing a listening area 26 as big as a theater audience. The WFS system synthesizes virtual loudspeakers 13 distributed around the listening area and enclosing the loudspeakers' array 5. The spatial filters 6 used to synthesize one virtual loudspeaker 12 contain gains and delays applied to each loudspeaker 5, depending on the position data embedded in the virtual loudspeaker description data with respect to the position associated with the loudspeakers description data 16 so as recreate a wave front emitted from the position of the virtual loudspeaker description data 8. The spatial filters 6 also contain individual equalization filter coefficient for each loudspeaker 5, that are computed from in-room measurements at one-meter distance of each loudspeaker.

The virtual sources are synthesized by amplitude panning between the virtual loudspeakers 12 using VBAP technique. The panning device 10 applies weights to each virtual loudspeakers 12 depending on the virtual source positioning data and virtual loudspeakers description data, so that the virtual source 13 is perceived at the virtual source positioning data 2. In the room rendering process, a primary virtual source 13, at the virtual source positioning data 2, emits the direct sound toward the listener. The primary virtual source also generates several reflections, considered as secondary virtual sources 13, each having its own virtual source positioning data 2, delay and gain, relative to the primary virtual source 13 (i.e. later in time and lower in level). The spatial rendering device 17 spatializes the primary virtual source 13 as well as the secondary virtual sources (reflections).

The source equalization-filtering device filters each virtual source 13 depending on its virtual source positioning data 2. The equalization filter coefficients 23 are stored in a filter database for each available virtual source positioning data 2. The equalization filter coefficients 23 are computed by a measurement of the impulse response of each virtual loudspeaker 12 on an array of microphones 20 distributed over all the listening area. For each virtual source positioning data 2, summing the measured impulse response each virtual loudspeaker 12 using the associated panning coefficients from the panning device 10 simulates the impulse response on each microphone 20. The source equalization filter coefficients finally results from a multichannel inversion problem where each impulse response simulated on one microphone 20 intends to fit a target profile depending on the microphone's 20 placement within the listening area 26. The target profile corresponds to perceptually good frequency response regarding timbre. Depending on the microphone's 20 location within the listening area, the target profile also corrects the possible room effect artifacts.

Applications of the invention are including but not limited to the following domains: hifi sound reproduction, home theatre, cinema, concert, shows, car sound, museum installation, clubs, interior noise simulation for a vehicle, sound reproduction for Virtual Reality, sound reproduction in the context of perceptual unimodal/crossmodal experiments.

Although the foregoing invention has been described in some detail for the purposes of clarity of understanding, it will be apparent that certain changes and modifications may be practiced within the scope of the appended claims. Accordingly, the present embodiments are to be considered as illustrative and not restrictive, and the invention is not limited to the details given herein, but may be modified with the scope and equivalents of the appended claims.

1. A method for spatial sound reproduction from a first audio input signal using a plurality of loudspeakers, said method using a plurality of virtual loudspeakers over which the first audio input signal is panned forming second audio input signals using source positioning data and virtual loudspeakers positioning data, said virtual loudspeakers being synthesized by modifying second audio input signals forming third audio input signals using virtual loudspeaker spatial filter coefficients (9) that align the loudspeakers, said method comprising the steps of:
extracting equalization filter coefficients using source positioning data; and,
modifying the first audio input signals using equalization filter coefficients.

2. The method of claim 1, wherein the equalization filter coefficients are retrieved from a filter database depending on the source positioning data.

3. The method of claim 1, wherein the equalization filter coefficients are calculated from an estimation of the reproduced sound field in the listening area.

4. The method of claim 3, wherein the estimation of the reproduced sound field in the listening area is performed by capturing the reproduced sound field on a plurality of microphones situated within the listening area.

5. The method of claim 4, wherein the reproduced sound field is measured on a plurality of microphones in the target listening environment.

6. The method of claim 4, wherein the reproduced sound field is simulated based on loudspeaker description data.

7. The method of claim 1, wherein the virtual loudspeaker spatial filter coefficients are calculated using loudspeaker description data and virtual loudspeakers positioning data.

8. The method of claim 7, wherein the virtual loudspeaker spatial filter coefficients comprise individual equalization of the loudspeakers.

9. The method of claim 7, wherein the virtual loudspeaker spatial filter coefficients are calculated for reproducing a target sound field at the ears of the listener using binaural reproduction over headphones or transaural reproduction over loudspeakers.

10. The method of claim 7, wherein the virtual loudspeaker spatial filter coefficients are calculated for sound field reproduction using wave field synthesis or high order ambisonics.

11. A method for spatial sound reproduction from a plurality of first audio input signal described by channel positioning data using a plurality of loudspeakers, said method using a plurality of virtual loud-speakers over which the first audio input signal, said virtual loudspeakers being synthesized by modifying first audio input signals forming third audio input signals using virtual loudspeaker spatial filter coefficients that align the loudspeakers, said virtual loudspeaker spatial filter coefficients being calculated based on channel positioning data, said method comprising the steps of:
performing a spatial analysis is performed on a plurality of input signals using channel positioning data (22) forming analysis positioning data; and,
extracting equalization filter coefficients using analysis positioning data, modifying the plurality of first audio input signals using equalization filter coefficients.

12. The method of claim 11, wherein the equalization filter coefficients are retrieved from a filter database depending on the analysis positioning data.

13. The method of claim 11, wherein the analysis positioning data are computed in a plurality of frequency bands.

14. The method of claim 11, wherein the equalization filter coefficients are computed in a plurality of frequency bands using the analysis positioning data.

15. The method of claim 11, wherein the equalization filter coefficients are calculated from an estimation of the reproduced sound field in the listening area.

16. The method of claim 15, wherein the estimation of the reproduced sound field in the listening area is performed by capturing the reproduced sound field on a plurality of microphones (20) situated within the listening area.

17. The method of claim 16, wherein the reproduced sound field is measured on a plurality of microphones in target listening environment.

18. The method of claim 16, wherein the reproduced sound field is simulated based on loudspeaker description data.

19. The method of claim 11, wherein the virtual loud-speaker spatial filter coefficients are calculated using loudspeaker description data and virtual loudspeakers positioning data.

20. The method of claim 19, wherein the virtual loud-speaker spatial filter coefficients comprise individual equalization of the loud-speakers.

21. The method of claim 19, wherein the virtual loud-speaker spatial filter coefficients are calculated for reproducing a target sound field at the ears of the listener using binaural reproduction over headphones or transaural reproduction over loudspeakers.

22. The method of claim 19, wherein the virtual loud-speaker spatial filter coefficients are calculated for sound field reproduction using wave field synthesis or high order ambisonics.
